(19) United States
(12) Patent Application Publication
(10) Pub. No.: US 2018/0077897 A1
(43) Pub. Date: Mar. 22, 2018

(54) Laser Pet Toy and Feeder

(71) Applicant: Tristan Christianson, San Francisco, CA (US)

(72) Inventor: Tristan Christianson, San Francisco, CA (US)

(73) Assignee: TGIF Design, inc., Novato, CA (US)

(21) Appl. No.: 15/708,133

(22) Filed: Sep. 19, 2017

Related U.S. Application Data
(60) Provisional application No. 62/397,880, filed on Sep. 21, 2016.

(51) Int. Cl. A01K 5/02; A01K 15/02; G02B 27/20; G02B 5/02

(52) U.S. Cl. CPC A01K 5/02; G02B 5/0215; G02B 27/20; A01K 15/025

(57) ABSTRACT

A pet toy and feeder comprising of a rotating laser module that projects laser beams to a laser shield enclosure and a feed chamber that dispenses feed to the animal interacting with the toy. The rotating laser module projects a beam to a laser shield enclosure that diffuses the beam such that the laser beam is visible on the surface of laser shield enclosure, but the laser beam does not travel outside of the enclosure to minimize risks of eye injuries due to exposure to laser beams.

### CROSS REFERENCE TO RELATED APPLICATIONS

This nonprovisional application claims benefit to priority of provisional patent application No. 62/397,880 filed on Sep. 21, 2016, incorporated herein by reference.

### STATEMENT REGARDING FEDERALLY SPONSORED RESEARCH AND DEVELOPMENT

None.

### FIELD OF THE INVENTION

The present invention relates to a device and method for engaging an animal and providing treats and nourishment.

### BACKGROUND

Laser pointers are commonly used to play and interact with domesticated pets because the movement of a laser pointer triggers the prey drive of a domesticated animal (typically a cat or a dog in most households). However, many animal behavioral science research reveal that a game of laser pointer chase can be very frustrating for the animal and can lead to behavioral problems. Specifically, the chase of a laser pointer beam amounts to be an unending game with no closure for the animal since they cannot ever catch the beam of light, like they can when chasing a toy or food.

Many animals continue looking for the light beam after the laser pointer has been put away; this is confusing for the animal because the prey has simply disappeared. This can create obsessive compulsive behaviors like frantically looking around for the light, staring at the last location they saw the light, and becoming reactive to flashes of light. Animals that exhibit such behavioral issues are frustrated, confused, and anxious.

Another immediate problem with laser pointers is that they are known to be hazardous to both human and animal eyesight and can cause eye injuries if an intense laser beam hits the eye. The current state of the art includes laser pet toys, but often they shine a laser beam outside the device which exposes pets and other animals including humans to potential/possible laser light emission which may be damaging to the eyes.

Yet another separate problem is that many pet owners feel guilty about leaving their pets at home during the day while they are at work and would likely feel better about leaving their pets at home during the day without unsupervised provided they know that their pets are engaged, are having fun and are being entertained. By keeping the pets engaged while their owners are away, the animals may be less likely to wreak havoc over the fragile or potentially expensive items in the home while left at home alone, unattended, but ideally the pet should be supervised while using the toy. The present invention relates to a device and method for engaging an animal and providing treats and nourishment.

Thus, against the backdrop of the problems identified above, this invention seeks to solve all the problems by creating a pet toy that uses laser pointer projections in a safe manner, combining the laser projections with a physical toy that the animal can interact and play with, and can potentially provide the animal treat or feed to reinforce positive behavior without all the risks and downsides of laser pointer animal toys found in the prior art.

### SUMMARY OF THE INVENTION

The present invention is directed to laser toy and automatic feeder for an animal. In one embodiment, the toy comprises of a laser module assembly that projects a laser beam onto a laser shield enclosure. The laser beam moves in a seemingly random fashion driven by a motor assembly on the base of the laser module assembly.

The toy further comprises a feed chamber that can be filled with animal feed. The feed chamber has a plurality of spillways that allow the feed to fall out of the chamber when the animal interacts with the toy. This is achieved through the shape of the toy where it is designed to rock and wobble around when an animal interacts with the toy. This in turn creates a positive reinforcement to the animal such that when it plays with the toy, it will be rewarded with food. The feed chamber is attached, but removable from the laser module assembly to facilitate cleaning and washing the chamber without getting the electronic components wet.

The laser module assembly is located at the base of the lower assembly. The laser module assembly can freely rotate in a 360-degree fashion and is capable of rotating clockwise and counterclockwise at random.

A motor is provided at the base of the laser module assembly to rotate the laser module assembly. The motor is connected to the laser by an axle, and a gear assembly is placed on said axle between the motor and laser to allow the laser to rotate. A set of contact rings held in place by a pair of electroconductive springs that complete the electrical circuit from the motor to the laser, allowing the motor to rotate the laser and also power the laser accordingly. The springs act as electrical conductors that make contact with the contact rings that in turn are electrical conductors to the laser. The springs are used in this embodiment as a replacement for wires because the wires would twist and actually break due to the constant rotations of the laser. Alternatively, the wires would severely limit the amount of allowable rotation of the laser.

A printed circuit board (PCB) or other similar electronic controls may be provided to toggle different functions and behavior to the laser module assembly. Specifically, the laser module assembly can be programmed to change its rotational direction at a certain interval, or active for a certain period of time before rotating in a different direction. The laser module assembly's rotational speed can also be adjusted as needed.

A motion sensor assembly can further be present to add further features to the laser function. Specifically, the motion sensor can be used to detect movements of the toy. For example, if the toy has not been interacted with for a certain period of time, the toy can go into sleep mode to conserve battery power. Another use of the motion sensor is to vary the laser's rotational speed and clockwise/counterclockwise direction when sufficient motion is detected by the motion sensor assembly to keep the animal occupied.

The laser beam is projected to a laser shield enclosure using a mirror placed substantially in front of the laser. The mirror is attached to a pivotable wave guiding post that traces the perimeter of a wavy circumferential edge of a cylinder. When the laser module assembly rotates, the wave guiding post traces along the top portion of the wavy cylinder, effectively changing the angle of elevation of the mirror during the rotation. As a result, the projected laser beam on the laser shield enclosure correspondingly rotates around at the same rate as the rotational speed of the laser module assembly, with the projected laser beam moving up and down corresponding to the elevation of the angle of the mirror that is attached to the wave guiding post.

This in effect creates an illusion of a laser beam that is projected to the inside surface of the laser shield enclosure that is visible from the outside of the laser shield enclosure. As a result, the animal sees a laser beam projection that moves around in a seemingly random fashion as the projected beam moves clockwise, counterclockwise, in addition to moving up or down along the laser shield enclosure. This seemingly random movements are likely to compel the animal to interact with the toy in order to “catch” the beam that is being projected to the laser shield enclosure.

The laser shield enclosure encloses the laser module assembly and creates a surface for projecting laser beams from the laser module assembly. The laser shield enclosure is made out a texturized, opaque material that allows to break up the laser beam dot to reduce and minimize beam hazard to eyes. This is a main safety factor of the toy in that the beam only projects a hot spot on the inside of the semi-opaque laser shield enclosure, and no pure laser beam can be emitted outside to the toy. The surface of the laser shield enclosure is textured to break up the beam so that the light of the laser dot (typically red) shining through the surface of the laser shield enclosure is safe and not harmful to the eyes of the animal or people close to the toy.

In an alternate embodiment, the feed chamber can be omitted such that the laser toy allows regular play with the animal. Without the feed chamber, the toy can be placed flat on the ground resulting in a much more stable toy, thus allowing more variety of design and shapes to the laser shield. The laser shield can in turn take a shape of a cube, a dome, or a conical shape, or any other shape suitable to attract an animal to play with the toy.

### BRIEF DESCRIPTION OF DRAWINGS

These and other features, aspects, and advantages of the present invention will become better understood with regard to the following descriptions, appended claims and accompanying drawings where:

FIG. 01 shows a perspective view of the Laser Toy and Automatic Feeder with laser shield enclosure and optional food chamber attached.

FIG. 02 shows a front view of the Laser Toy and Automatic Feeder with laser shield enclosure, optional food chamber attached, and battery door.

FIG. 03 shows a left view of the Laser Toy and Automatic Feeder with laser shield enclosure, optional food chamber attached, and battery door.

FIG. 04 shows a right view of the Laser Toy and Automatic Feeder with laser shield enclosure, optional food chamber attached, and battery door.

FIG. 05 shows a rear view of the Laser Toy and Automatic Feeder with laser shield enclosure, optional food chamber attached, and battery door.

FIG. 06 shows a bottom view of the Laser Toy and Automatic Feeder with battery door, food chamber attached, and the food spillway shown.

FIG. 07 shows a bottom perspective view of the Laser Toy and Automatic Feeder with battery door, food chamber attached, and the food spillway shown.

FIG. 08 shows a cutaway side view of the Laser Toy and Automatic Feeder with battery door, food chamber attached, and the food spillway shown. This cutaway side view also shows some of the structure of the laser module assembly and motor assembly.

FIG. 09 shows an alternate cutaway side view of the Laser Toy and Automatic Feeder with battery door, food chamber attached, and the food spillway shown. This cutaway side view also shows some of the structure of the laser module assembly, motor assembly and motion sensor.

FIG. 10 shows an alternate cutaway side view of the Laser Toy and Automatic Feeder with a laser beam projected to the surface of the outer housing laser shield enclosure via the mirror.

FIG. 11 shows an exploded view of the Laser Toy and Automatic Feeder illustrating the laser shield enclosure and lower assembly.

FIG. 12 shows an exploded view of the Laser Toy and Automatic Feeder showing the feed chamber separated from the lower assembly with the battery cover removed.

FIG. 13 shows an exploded view of the Laser Toy and Automatic Feeder showing the Lower Assembly, Laser Module Assembly, and Motion Sensor Assembly.

FIG. 14 shows an exploded view of the Laser Toy and Automatic Feeder showing the removable feed chamber and battery cover.

FIG. 15 shows a partially exposed view of the laser shield enclosure showing the lower assembly, laser module assembly, and motion sensor assembly.

FIG. 16 shows a perspective view of the lower assembly, laser module assembly, and motion sensor assembly.

FIG. 17 shows a side view of the lower assembly, laser module assembly and motion sensor.

FIG. 18 shows a perspective view of the upper laser module assembly and motor assembly.

FIG. 19 shows a perspective view with a partial cutaway of the housing of the laser module assembly showing the internal structure of the laser module assembly.

FIG. 20 shows an alternate view of the lower laser module assembly where the laser, mirror, wave tracking post, and lower assembly are shown.

FIG. 21 shows a perspective view with a partial cutaway of the housing of the laser module assembly showing the internal structure of the laser module assembly.

FIG. 22A illustrates the loading process by inserting feed or kibbles to the Laser Toy and Automatic Feeder through the feed chamber spillway.

FIG. 22B shows a Laser Toy and Automatic Feeder projecting a laser beam and attracting an animal to play with the toy.

FIG. 22C shows a Laser Toy and Automatic Feeder dispensing feed or treats to an animal after the animal interacts and plays with the toy.

FIG. 23A shows an alternate embodiment of the Laser Toy where the laser shield enclosure is shaped as a half-dome.

FIG. 23B shows an alternate embodiment of the Laser Toy where the laser shield enclosure is shaped as a cube.

FIG. 23C shows an alternate embodiment of the Laser Toy where the laser shield enclosure is shaped as a cone.

### REFERENCE NUMBER INDEX

100—Laser Shield Enclosure

101—Inner Surface

102—Laser Beam

103—Laser Beam Projection

200—Feed Chamber

201—Feed Chamber Spillway

202—Feed Chamber Locking Tab

300—Lower Assembly

301—Motion Sensor Assembly

302—Wave Guide Cylinder

303—Locking Tab Insert

400—Laser Module Assembly

401—Laser

402—Mirror

403—Wave Tracking Post

404—Spring

405—Gear Assembly

406—Motor Assembly

407—Printed Circuit Board (PCB)

408—Contact Rings

500—Battery Door

501—Power Switch

502—Battery Port

503—Screw

### DETAILED DESCRIPTION OF THE PREFERRED EMBODIMENT

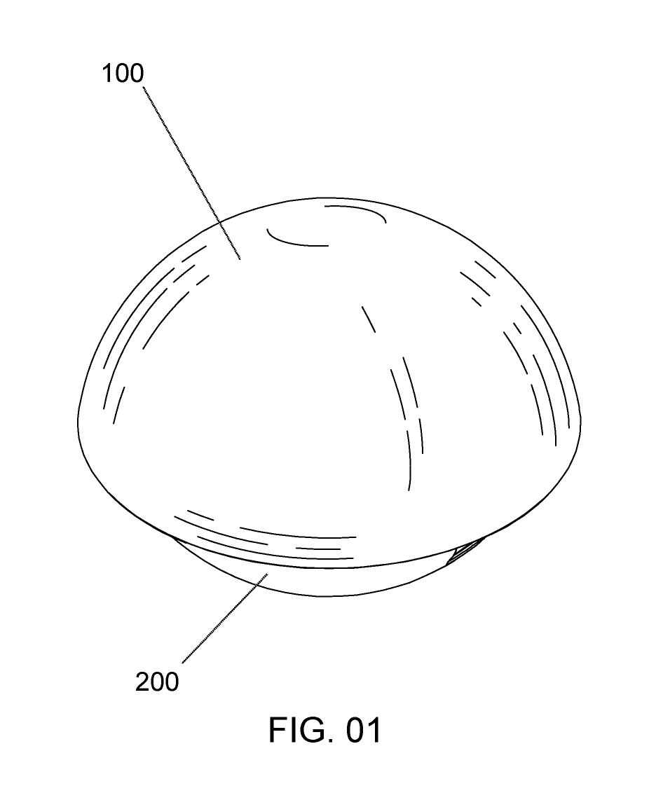

FIG. 01 shows a perspective view of the Laser Toy and Automatic Feeder with laser shield enclosure 100 and feed chamber 200.

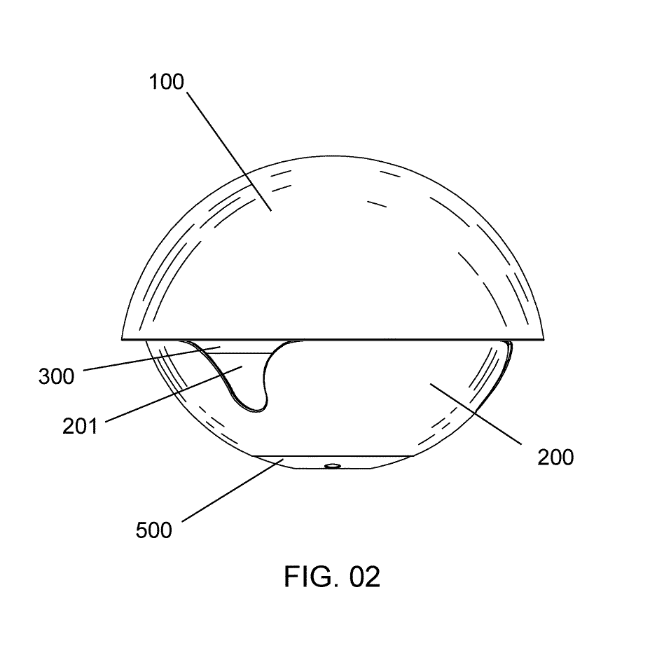

FIG. 02 shows a front view of the Laser Toy and Automatic Feeder with laser shield enclosure 100 and feed chamber 200 with breaks in the perimeter to expose the feed chamber spillway 201. The spillway 201 acts as an opening to both fill and dispense feed from and to the feed chamber 200. The lower assembly 300 is also shown as covered with feed chamber 200.

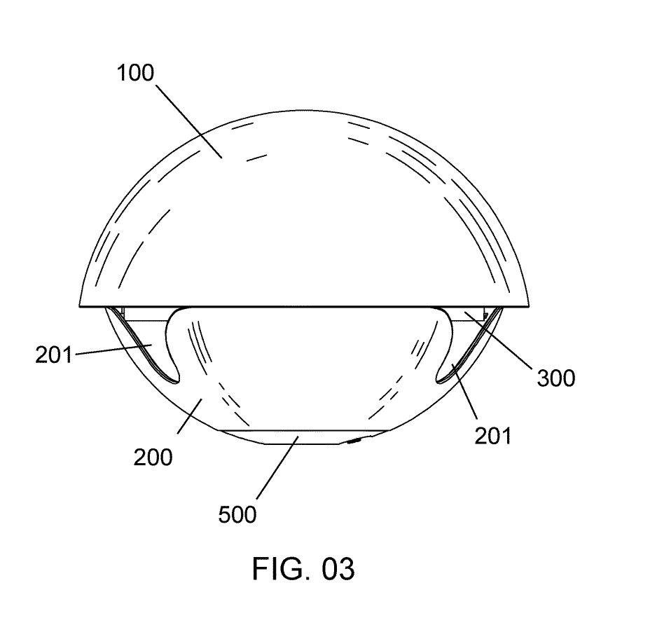

FIG. 03 shows a left view of the Laser Toy and Automatic Feeder with laser shield enclosure 100 and feed chamber 200 with breaks in the perimeter to expose the feed chamber spillway 201. The lower assembly 300 is also shown as covered with feed chamber 200. The battery door 500 is shown at the bottom of the feed chamber 200.

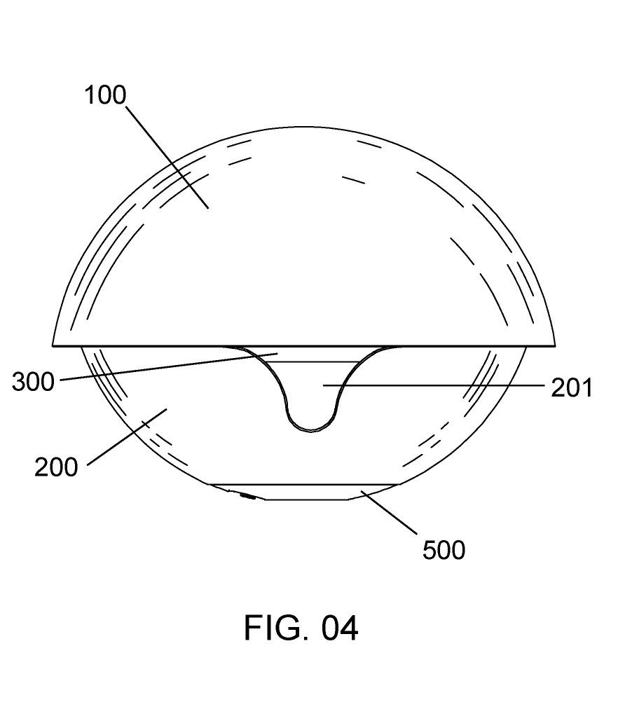

FIG. 04 shows a right view of the Laser Toy and Automatic Feeder with laser shield enclosure 100 and feed chamber 200 with breaks in the perimeter to expose the feed chamber spillway 201. A pet owner can fill the feed chamber by carefully pouring the feed or treat into one of the spillways until the chamber is reasonably filled. The lower assembly 300 is also shown as covered with feed chamber 200. The battery door 500 is shown at the bottom of the feed chamber 200.

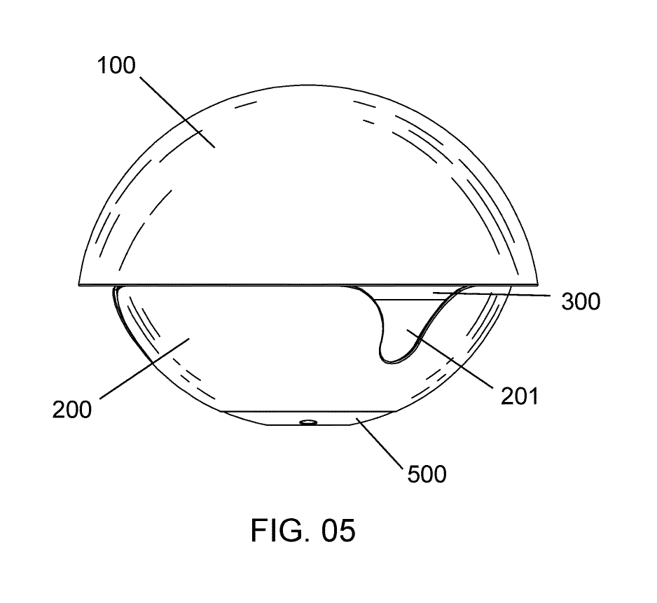

FIG. 05 shows a rear view of the Laser Toy and Automatic Feeder with laser shield enclosure 100 and feed chamber 200 with breaks in the perimeter to expose the feed chamber spillway 201. The lower assembly 300 is also shown as covered with feed chamber 200. The battery door 500 is shown at the bottom of the feed chamber 200.

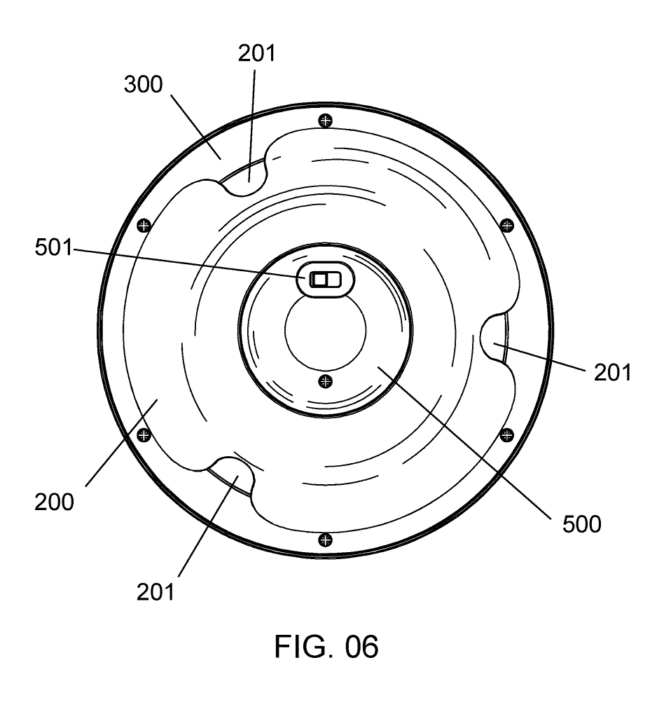

FIG. 06 shows a bottom view of the Laser Toy and Automatic Feeder with feed chamber 200 with breaks in the perimeter to expose the feed chamber spillway 201. The lower assembly 300 is also shown. The battery door 500 is shown at the bottom of the feed chamber 200 with power switch 501. The power switch allows the pet owner to toggle the toy on and off, and may also be implemented with other features such as normal/fast laser rotation, randomized rotational direction, or any other features that alter the behavior of the laser.

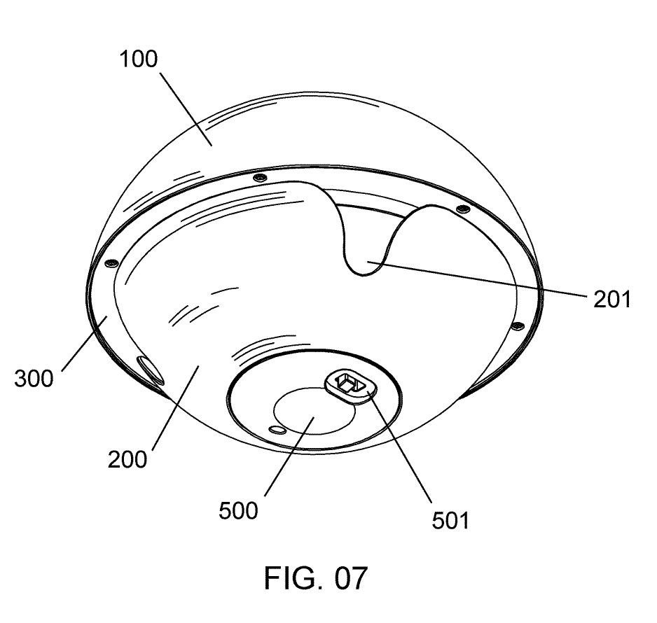

FIG. 07 shows a bottom perspective view of the Laser Toy and Automatic Feeder with feed chamber 200 with breaks in the perimeter to expose the feed chamber spillway 201. The lower assembly 300 is also shown. The battery door 500 is shown at the bottom of the feed chamber 200 with power switch 501.

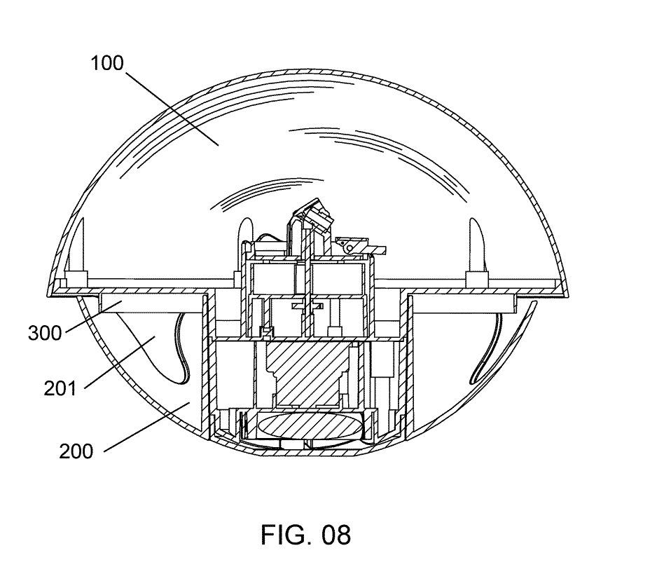

FIG. 08 shows a cutaway side view of the Laser Toy and Automatic Feeder with laser shield enclosure 100 and feed chamber 200 with breaks in the perimeter to expose the feed chamber spillway 201. The lower assembly 300 is also shown as covered with feed chamber 200.

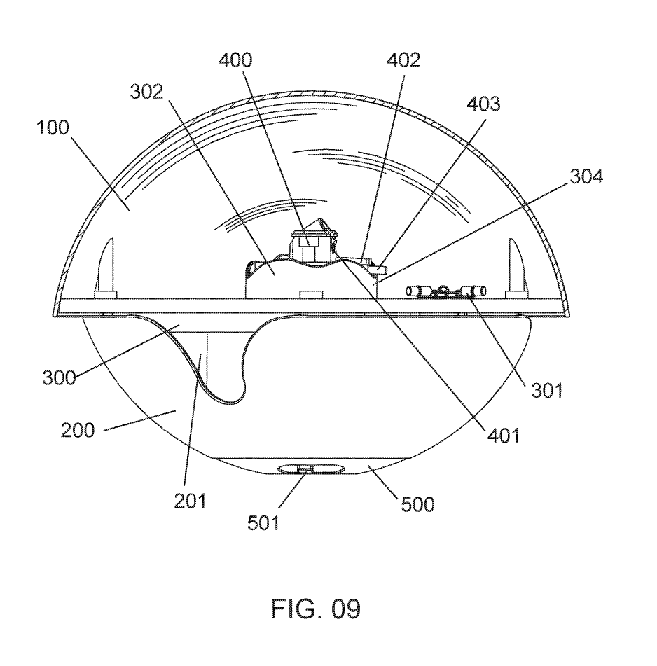

FIG. 09 shows an alternate cutaway side view of the Laser Toy and Automatic Feeder with laser shield enclosure 100 and feed chamber 200 with breaks in the perimeter to expose the feed chamber spillway 201. The lower assembly 300 is also shown with motion sensor assembly 301, mirror 402 for the laser 401, and wave tracking post 403, and wave guide cylinder 302, and motion sensor assembly 301. The battery door 500 and power switch 501 are also shown at the bottom of the feed chamber 200.

The motion sensor assembly 301 can be used to detect movements of the toy. For example, if the toy has not been interacted with for a certain period of time, the toy can go into sleep mode to conserve battery power. Another use of the motion sensor is to vary the laser's rotational speed and clockwise/counterclockwise direction when sufficient motion is detected by the motion sensor assembly to keep the animal occupied.

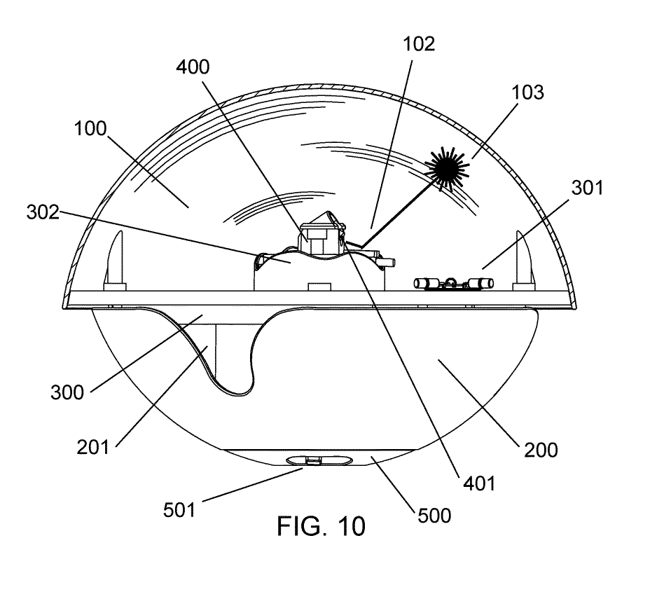

FIG. 10 shows an alternate cutaway side view of the Laser Toy and Automatic Feeder with a laser beam 102 projected to the surface of the outer housing laser shield enclosure 100 as indicated by the laser beam projection 103. It should be noted that the inner surface 101 of the laser shield enclosure 100 is made of a semi-opaque material its inner surface can manufactured or coated with a textured material to safely diffuse the laser beam and prevent the beam from exiting the laser shield enclosure while keeping the projection visible from the outside. This can also be achieved by introducing a color tint (typically red since red is the most common laser color used in the industry). In this manner, the animal can see the projection and keeps its attention on the toy rather than an astray laser beam projection on a random wall or other surface inside a room.

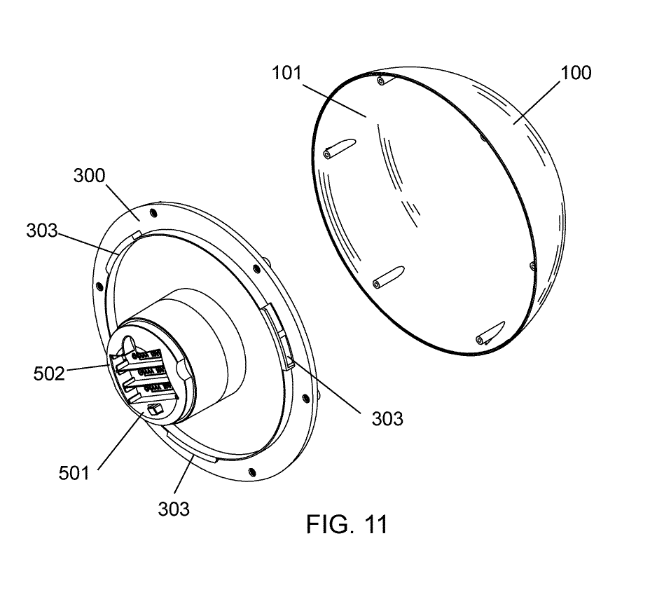

FIG. 11 shows an exploded view of the Laser Toy and Automatic Feeder illustrating the laser shield enclosure 100 and lower assembly 300 with locking tab inserts 303. The inner surface of the laser shield enclosure 101 may be coated with a surface coating as previously described. Also seen is the battery port 502 and power switch 501.

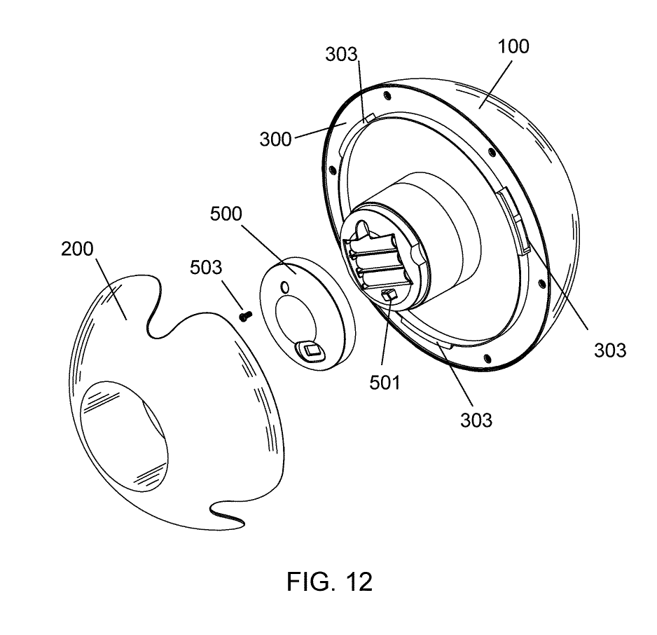

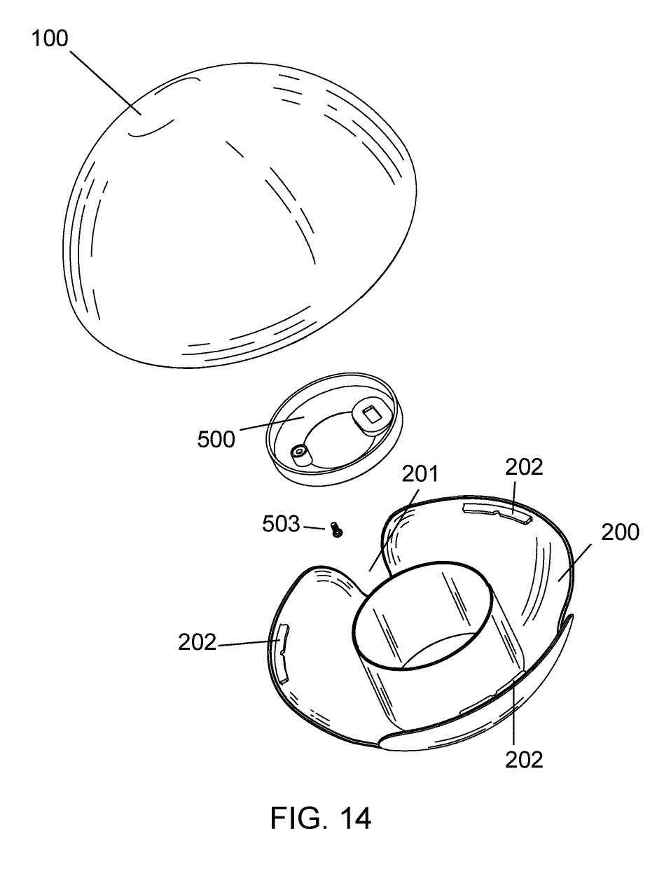

FIG. 12 shows an exploded view of the Laser Toy and Automatic Feeder showing the feed chamber 200 removed from the lower assembly 300 with the battery door 500 removed by removing screw 503. The lower assembly has a plurality of locking tab inserts 303 that can interact with the feed chamber locking tabs 202 as seen in FIG. 14.

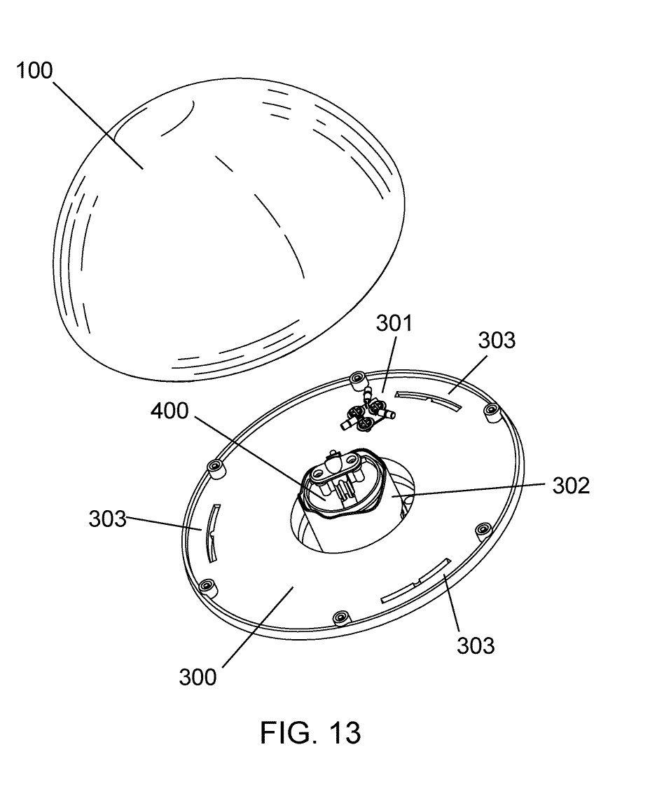

FIG. 13 shows an exploded view of the Laser Toy and Automatic Feeder showing the laser shield enclosure 100, lower assembly 300, motion sensor assembly 301, locking tab inserts 303, and laser module assembly 400.

FIG. 14 shows an exploded view of the Laser Toy and Automatic Feeder showing the laser shield enclosure 100, battery door 500, removable feed chamber 200. In this view, the lower assembly is attached to the laser shield enclosure 100 such that it cannot be seen from this view. The feed chamber has a plurality of locking tabs 202 that can be inserted to the locking tab inserts 303 as seen previously in FIG. 12 and secures the feed chamber to the lower assembly using a twist-lock mechanism.

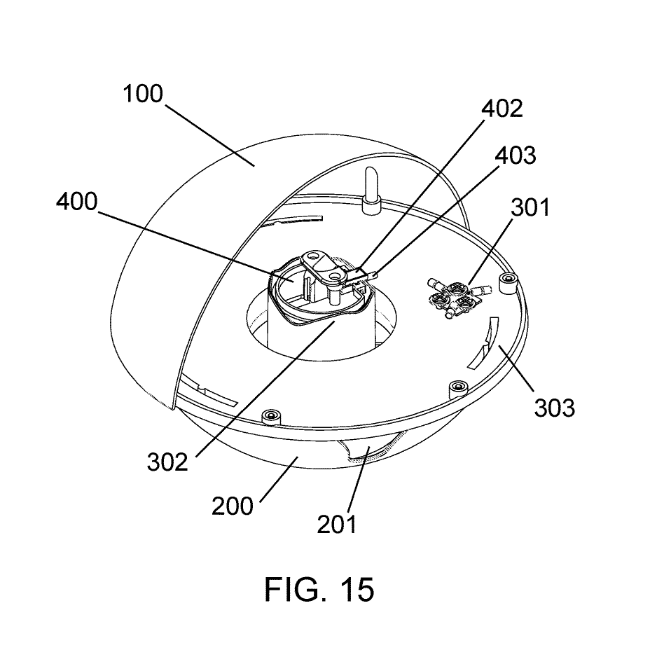

FIG. 15 shows a partially exposed view of the laser shield enclosure showing the laser shield enclosure 100, food chamber 200, food chamber spillway 201, lower assembly 300, motion sensor assembly 301, laser module assembly 400, mirror 402, and wave tracking post 403.

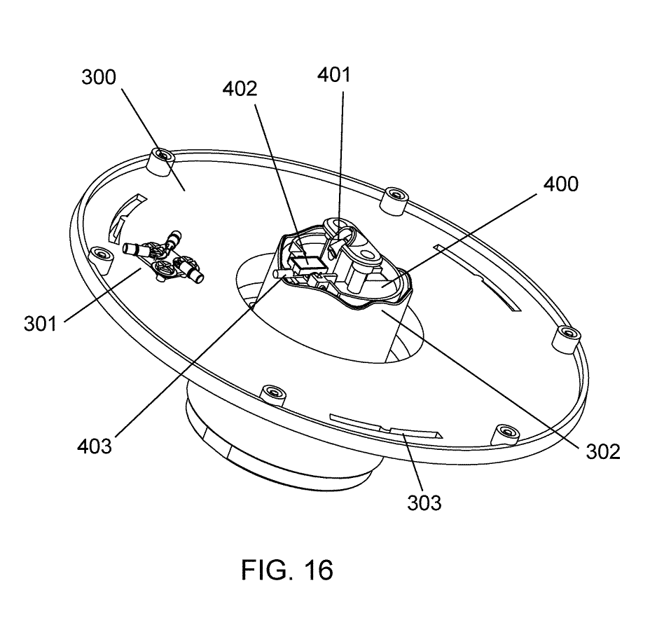

FIG. 16 shows a perspective view of the lower assembly 300, laser module assembly 400, and motion sensor assembly 301 located on the lower assembly.

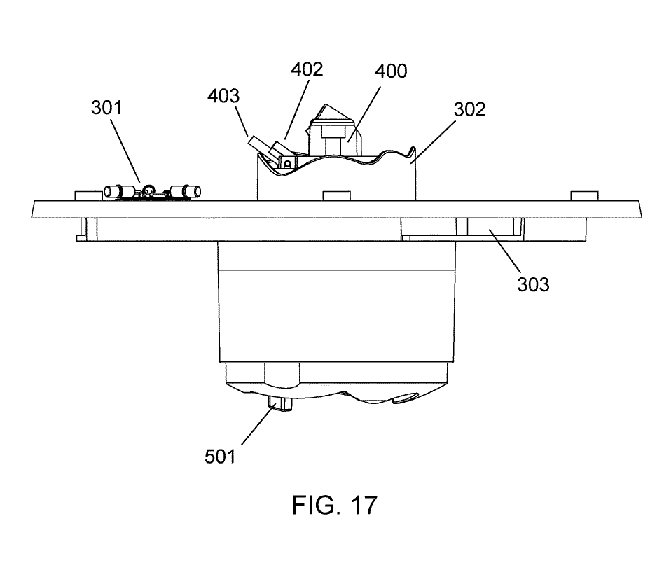

FIG. 17 shows a side view of the lower assembly 300, laser module assembly 400, equipped with laser 401, mirror 402, wave tracking post 403, and motion sensor assembly 301. Also shown in this view is the plurality of locking tab inserts 303.

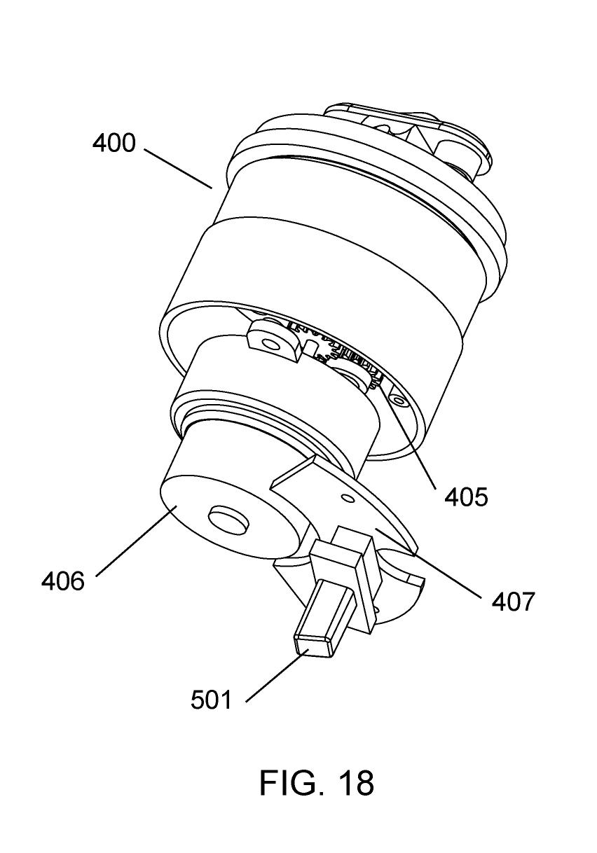

FIGS. 18 through 21 show the laser module assembly 400 and its various parts.

FIG. 18 shows a perspective view of the laser module assembly 400 and motor assembly 406 at its base, followed by the gear assembly 405, and power switch 501 connected to the PCB 407.

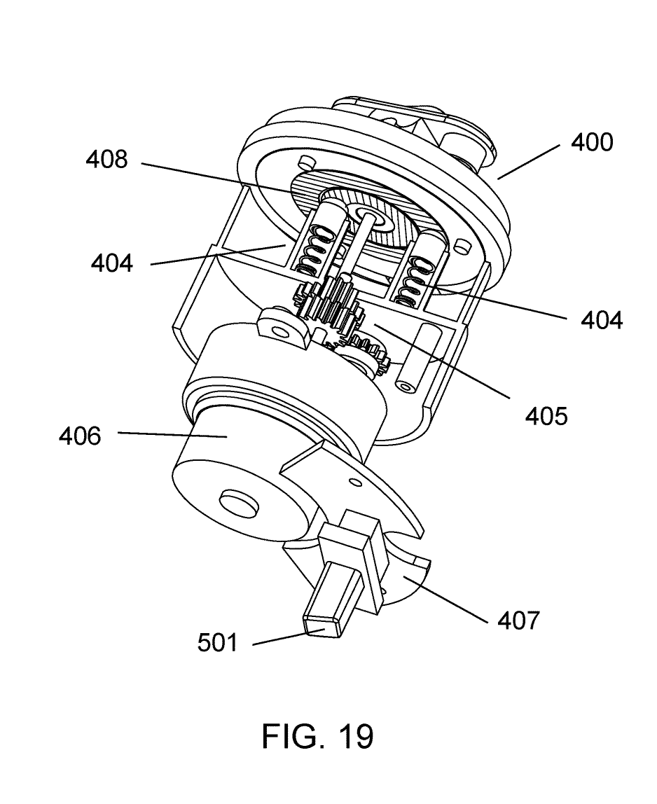

FIG. 19 shows a perspective view with a partial cutaway of the housing of the laser module assembly 400 showing the contact springs 404, the contact rings 408, the gear assembly 405, motor assembly 406, and power switch 501. A set of contact rings 408 held in place by a pair of contact springs 404 that act as electrical conductors completing the electrical circuit from the motor to the laser, allowing the motor to rotate the laser and also power the laser accordingly. The contact springs 404 act as electrical conductors that make contact with the contact rings 408 that in turn are electrical conductors to the laser 401. The springs are used in this embodiment as a replacement for wires because the wires would twist and actually break due to the constant rotations of the laser. Alternatively, the wires would severely limit the amount of allowable rotation of the laser.

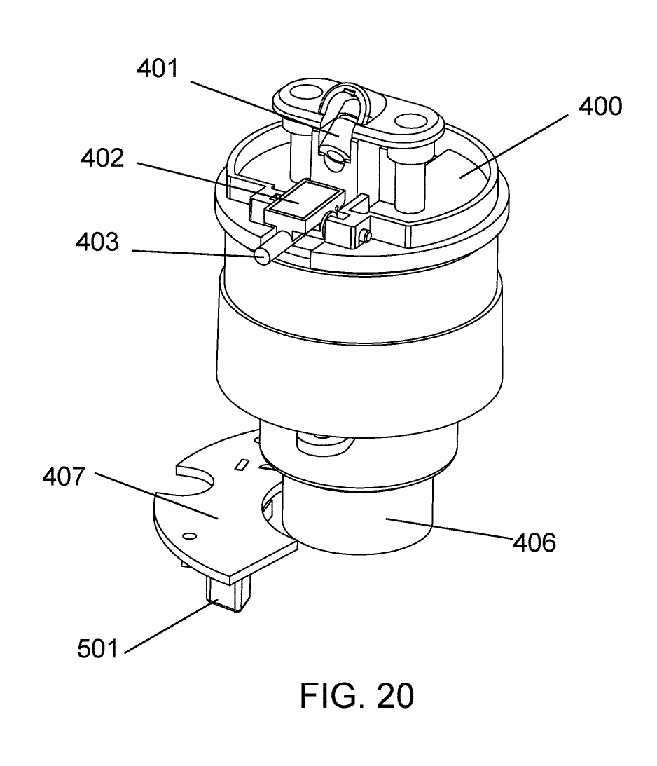

FIG. 20 shows an alternate view of the laser module assembly 400 where the laser 401, mirror 402, wave tracking post 403, all of which situated above the motor assembly 406, which in turn connected to the printed circuit board (PCB) 407 with the power switch 501.

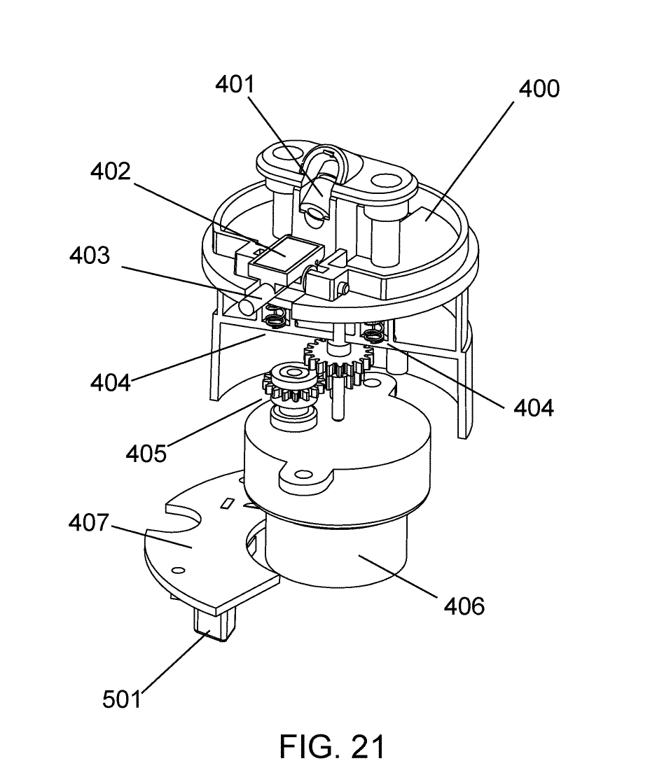

FIG. 21 shows a perspective view of the laser module assembly with a partial cutaway of the housing of the laser module assembly showing the internal structure of the laser module assembly to further illustrate the proximity of the parts described in the preceding paragraphs above.

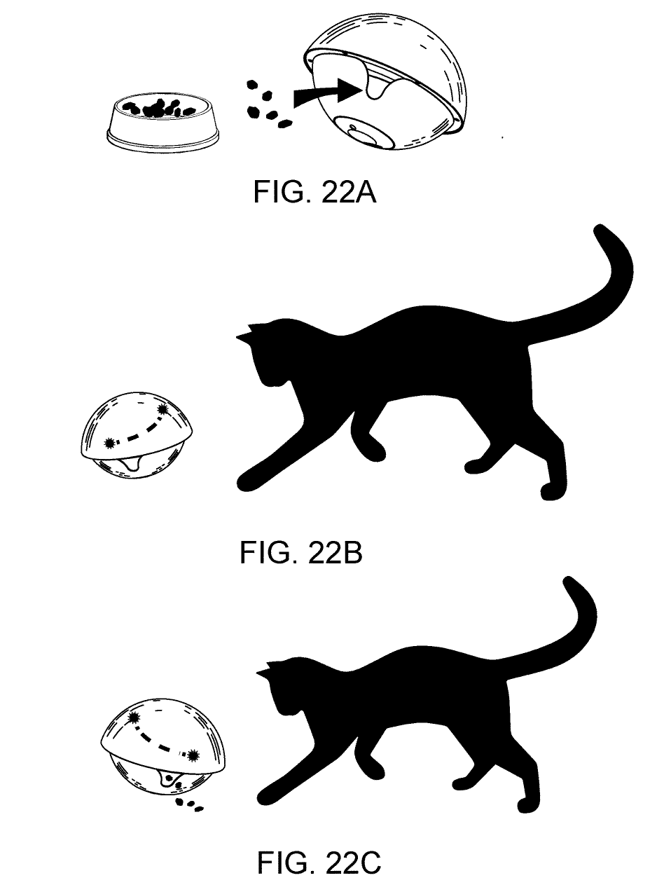

FIG. 22A illustrates the loading process by inserting feed or kibbles to the Laser Toy and Automatic Feeder through the feed chamber spillway.

FIGS. 22B and 22C shows a Laser Toy and Automatic Feeder projecting a laser beam and attracting an animal to play with the toy, and when the animal successfully interacts with the toy, the toy will dispense feed from the feed chamber spillway, allowing the toy to reward the animal for playing with the toy.

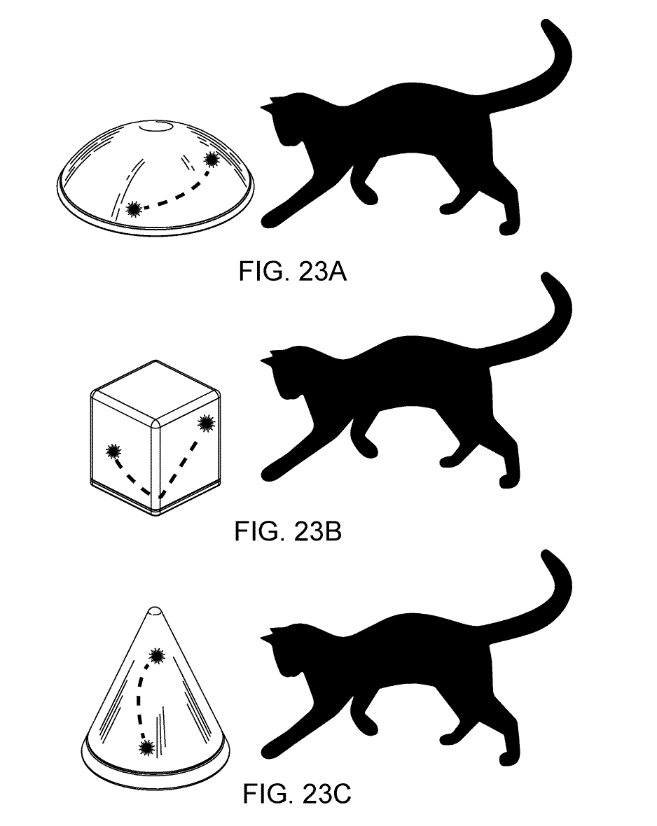

FIGS. 23A through 23C shows an alternate embodiment in which the feed chamber 200 is omitted and the toy is presented solely as a laser toy without the feed feature.

FIG. 23A shows an alternate embodiment of the Laser Toy where the laser shield enclosure is shaped as a half-dome.

FIG. 23B shows an alternate embodiment of the Laser Toy where the laser shield enclosure is shaped as a cube.

FIG. 23C shows an alternate embodiment of the Laser Toy where the laser shield enclosure is shaped as a cone.

In the Summary of the Invention above and in the Detailed Description of the Invention, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm.

Although the present invention has been described in considerable detail with reference to certain preferred versions thereof, other versions are possible. Therefore, the spirit and scope of the appended claims should not be limited to the description of the preferred version contained herein.

I claim:

1) A laser pet toy and automatic feeder, comprising:
a) a laser module assembly, having:
i) a rotating laser;
ii) a mirror;
iii) a wave tracking post;
iv) a wave guide cylinder having a wavy circumferential perimeter;
v) a power source;
b) a laser shield enclosure; and
c) a feed chamber.

2) A laser pet toy and automatic feeder of claim 1, wherein the mirror is attached to the wave tracking post and the laser is aimed at said mirror to reflect a laser beam.

3)A laser pet toy and automatic feeder of claim 3, wherein the wave guide cylinder has an asymmetric profile about the circumferential perimeter of said wave guide cylinder for the wave guide post to ride thereon.

4) A laser pet toy and automatic feeder of claim 4, wherein the wave guide post rides on the wave guide cylinder about the wavy profile of the circumferential perimeter of the wave guide cylinder thereby tilting the mirror to change the spatial location of the laser beam spot on the laser shield enclosure creating a moving projection on the said laser shield enclosure.

5) A laser pet toy and automatic feeder of claim 1, wherein the laser shield enclosure is coated with a coating selected from the group consisting of a reflective material and a color tint.

6) A laser pet toy and automatic feeder of claim 1, wherein the motor assembly contains conductive contact springs that ride on contact rings to provide power for the laser to emit light and freely rotate.

7) A laser pet toy and automatic feeder of claim 1, wherein the feed chamber can be loaded with dry pet food.

8) A laser pet toy and automatic feeder of claim 1, wherein laser pet toy and automatic feeder further comprises a motion sensor assembly.

9) A laser pet toy and automatic feeder of claim 1, wherein the laser shield housing shape is selected from the group consisting of a dome, a cone, a rectangular shape and a polyhedron. 10) A laser pet toy, comprising:
a) a laser module assembly, having:
i) a rotating laser;
ii) a mirror;
iii) a wave guiding post;
iv) a wave guide cylinder having a wavy circumferential perimeter;
v) a power source; and
b) a laser shield enclosure.

11) A laser pet toy claim 11, wherein the mirror is attached to the wave guide post and the laser is aimed at said mirror.

12) A laser pet toy claim 13, wherein the wave guide cylinder has an asymmetric profile about the circumferential perimeter of said wave guide cylinder for the wave guide post to ride thereon.

13) A laser pet toy of claim 14, wherein the wave guide post rides on the wave guide cylinder about the asymmetric profile of the circumferential perimeter of the wave guide cylinder thereby tilting the mirror to change the spatial location of the laser beam spot on the laser shield housing creating a pattern on the said laser shield housing.

14) A laser pet toy of claim 11, wherein the laser shield housing is coated with a coating selected from the group consisting of a reflective material and a color tint.

15) A laser pet toy of claim 11, wherein the motor assembly contains conductive contact springs that ride on contact rings to provide power for the laser to emit light and freely rotate.

16) A laser pet toy of claim 11, wherein laser pet toy and automatic feeder further comprises a motion shake sensor assembly puts the device to sleep.

17) A laser pet toy and automatic feeder of claim 11, wherein the laser shield housing shape is selected from the group consisting of a dome, a cone, a rectangular shape and a polyhedron.

18) A laser pet toy and automatic feeder of claim 11, wherein the laser beam is positioned about the internal surface of the laser shield without the mirror.
